(19) United States
(12) Patent Application Publication
(10) Pub. No.: US 2007/0290087 A1
(43) Pub. Date: Dec. 20, 2007

(54) Bale processor

(76) Inventor: Leonard D. Weiss, Brush, CO (US)

Correspondence Address: Dean P. Edmundson, P.O. Box 179, Burton, TX, 77835, US

(21) Appl. No.: 11/820,309

(22) Filed: Jun. 19, 2007

Related U.S. Application Data
(63) Continuation-in-part of application No. 11/243,616, filed on Oct. 5, 2005.
(60) Provisional application No. 60/618,673, filed on Oct. 14, 2004.

(51) Int. Cl. B02C 19/00

(52) U.S. Cl. 241/101.76; 241/277; 241/282.2

(57) ABSTRACT

Bale processing apparatus is disclosed which includes an elongated bed for supporting a bale of forage to be processed. Cutting blades are carried on transverse shafts at one end of the apparatus, and a conveyer advances the bale along the bed toward the cutting blades. Cut forage material is dispensed laterally outward from the bed either to the right side or to the left side, as desired. The position of the transverse shafts and the location of the cutting knives can be changed without having to disassemble the apparatus.

### CROSS-REFERENCE TO RELATED APPLICATIONS

This application is a continuation-in-part of my earlier copending application Ser. No. 11/243,616, filed Oct. 5, 2005, which was based on, and claims priority from, my Provisional Application No. 60/618,673, filed Oct. 14, 2004.

### FIELD OF THE INVENTION

This invention relates to equipment used for processing bales of forage such as hay or straw. More particularly, in one embodiment this invention relates to equipment which can be towed behind a tractor, or be truck-mounted, for processing large bales.

### BACKGROUND OF THE INVENTION

It is common for farmers, ranchers, dairies, feedlot operators, etc. to use large bales of forage such as hay or straw when feeding or bedding their animals. Large bales are sometimes also used for mulch when planting grass along roadways, for example, or for land reclamation.

Conventional bale processors include large tub grinders and also smaller units which can be towed behind a tractor. All of such equipment typically utilizes a rotating shaft having a number of spaced hammers along its length. The shaft is rotated at high speed so that the hammers are able to beat and tear the forage off the bale being processed. Unfortunately, this action also results in much of the forage being pulverized into very small pieces, thereby creating a considerable amount of dust which is very undesirable. Any dust particles which blow or drift away in the wind are lost. Furthermore, very small particles of forage fed to animals are not desirable as feed.

There has not heretofore been provided a bale processor having the advantages of the bale processor described herein.

### SUMMARY OF THE INVENTION

In accordance with the present invention there is provided a bale processor which does not utilize the hammers which are typically found on conventional bale processors. In accordance with one embodiment of the present invention there is provided a bale processor which comprises:
(a) an elongated bed having first and second ends;
(b) mill means supported at the first end of the bed; wherein the mill means comprises at least one rotatably driven transverse shaft with a plurality of cutting means secured to it;
(c) conveyor means on the bed for advancing a bale longitudinally along the bed toward the mill means;
(d) dispensing means adjacent the mill means for dispensing cut material from the bale laterally relative to the bed, i.e. the cut material is dispensed outwardly from one side of the bed or the other, as desired.

The forage material in the bale is cut to a desired length (e.g. 3 inches) by the cutting blades or knives. Because the forage material is cut into a desired length, it is not ground into fine particles or powder. This avoids the formation of dust which typically results from the use of tub grinders. The efficiency of the processor of this invention results in less horsepower and fuel requirements than are needed for operating other bale processors. There is also less maintenance and wear. The types of cutting blades or knives may vary, and the spacing between adjacent blades or knives may also vary, as desired.

### BRIEF DESCRIPTION OF THE DRAWINGS

FIG. 1 is a front perspective view showing one embodiment of a bale processor of the invention;

FIG. 2 is an enlarged perspective view of a portion of the embodiment shown in FIG. 1;

FIG. 3 is an elevational view of the embodiment of cutting mill which is shown in FIG. 1;

FIG. 4 is a perspective view of one of the shafts used in the mill of FIG. 3 on which there are mounted several cutting blades on a plurality of parallel transverse shafts;

FIG. 5 is a perspective view showing one type of hub which may be used in order to secure a cutting blade to one of the rotatable shafts;

FIG. 6 is a side elevational view of a split hub which is useful in this invention;

FIG. 7 is a side elevational view showing one type of cutting blade system which may be used in this invention;

FIG. 7A is an edge view of a portion of blade 30 taken along line 10A-10A in FIG. 7;

FIG. 8 is a side elevational view showing the use of adjustable pillow blocks in the processor of this invention;

FIG. 9 is an elevational view illustrating different manners in which cutting blades may be attached to one of the rotating shafts;

FIG. 10 is a top plan view of another embodiment of bale processor of this invention;

FIG. 11 is a perspective view of another embodiment of mill for shredding bales and forage material in this invention;

FIG. 12 is a side elevational view of the embodiment of FIG. 11;

FIG. 13 is a perspective view of another embodiment of knife system for use in the processor of this invention;

FIG. 14 is a front elevational view of the knife system of FIG. 13 on a shaft for use in the bale processor;

FIG. 15 is a perspective view of another embodiment of knife system for use in the processor of this invention;

FIG. 16 illustrates a blower attachment which can be mounted on either end of the front transverse conveyor for blowing forage material outwardly from the apparatus, either toward the right side of the apparatus or toward the left side, as desired.

### DETAILED DESCRIPTION OF THE INVENTION

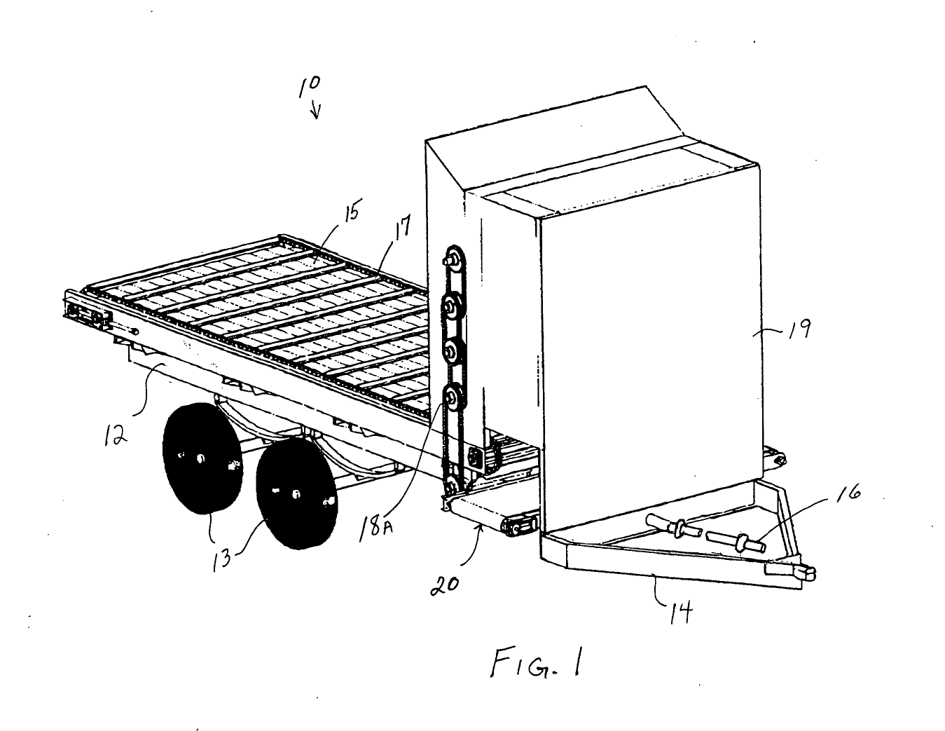

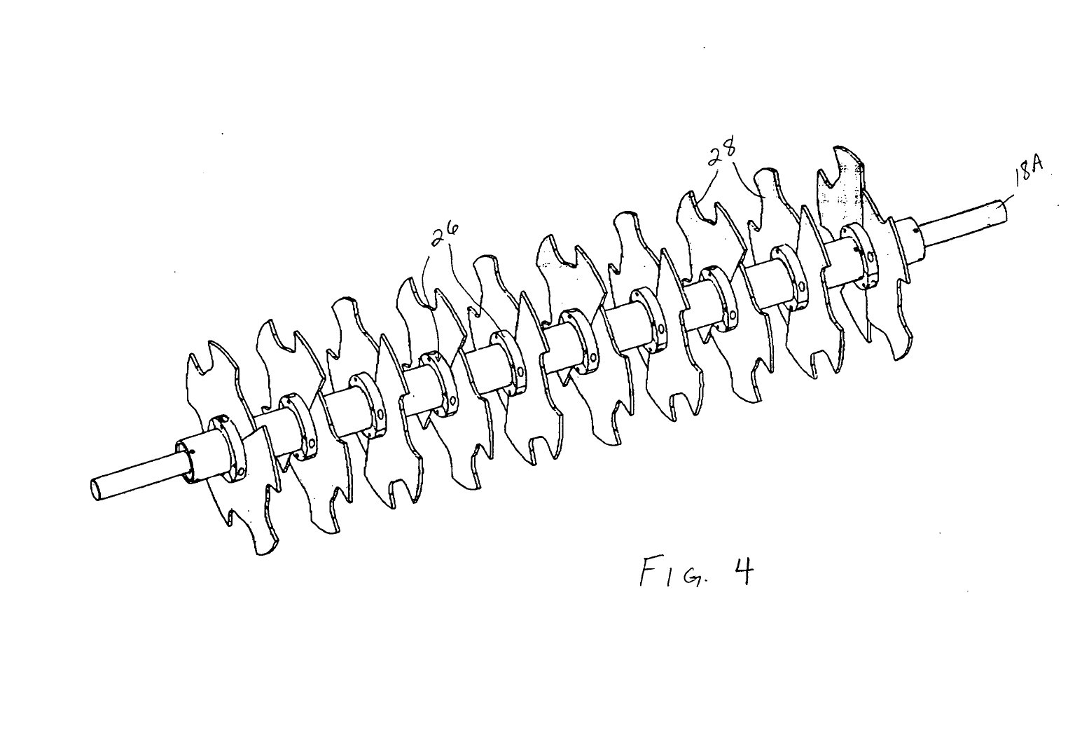

In FIGS. 1-10 there is shown one embodiment of a bale processor 10 of the invention comprising an elongated frame 12, carried on wheels 13, with hitch 14 for towing and including an elongated bed 15 on which large round or square bales to be processed are carried. At the forward end of the bed the processor mill 18 is located (surrounded on three sides by enclosure or shroud 19), and it comprises at least one (or a plurality of) horizontal rotatable shafts 18A extending across the width of the bed. On each shaft there are mounted several cutting knives or blades 28 (which are preferably composed of hardened steel). Each shaft may have a circular cross-section, or it may have a non-circular cross-section. Preferably each cutting blade comprises two separate elements which can be secured to one of the hubs on the shaft. The cutting blade is forced to rotate with the shaft.

The diameter of the cutting blades may vary (e.g. from about 12 inches to about 24 inches or even larger). A diameter of about 20 to 24 inches is currently preferred. Preferably the periphery of the blades is serrated, as illustrated, for improved cutting performance on the forage. The speed of rotation of the shafts and blades or knives may vary, (e.g. from about 60 rpm to about 300 or more rpm), although a speed of about 300 rpm is preferred. If the speed is too high, then the forage material may be cut into pieces which are considered to be too fine. The knives on each shaft are preferably offset laterally about 6 inches from the knives on an adjacent shaft. The shafts and knives can also be driven in a reverse rotational direction (e.g. if necessary to unplug forage material which may have become jammed between the knives). It is also possible to include a plurality of kicker plates on the rotatable shafts, mid-way between adjacent cutting knives, for the purpose of kicking frozen chunks or lumps of forage backward toward the bale so that they can be processed further to reduce their size. The kicker plate may be, for example, a rectangular plate secured to the rotatable shaft and being forced to rotate with the shaft. Other configurations for a kicker plate may be used.

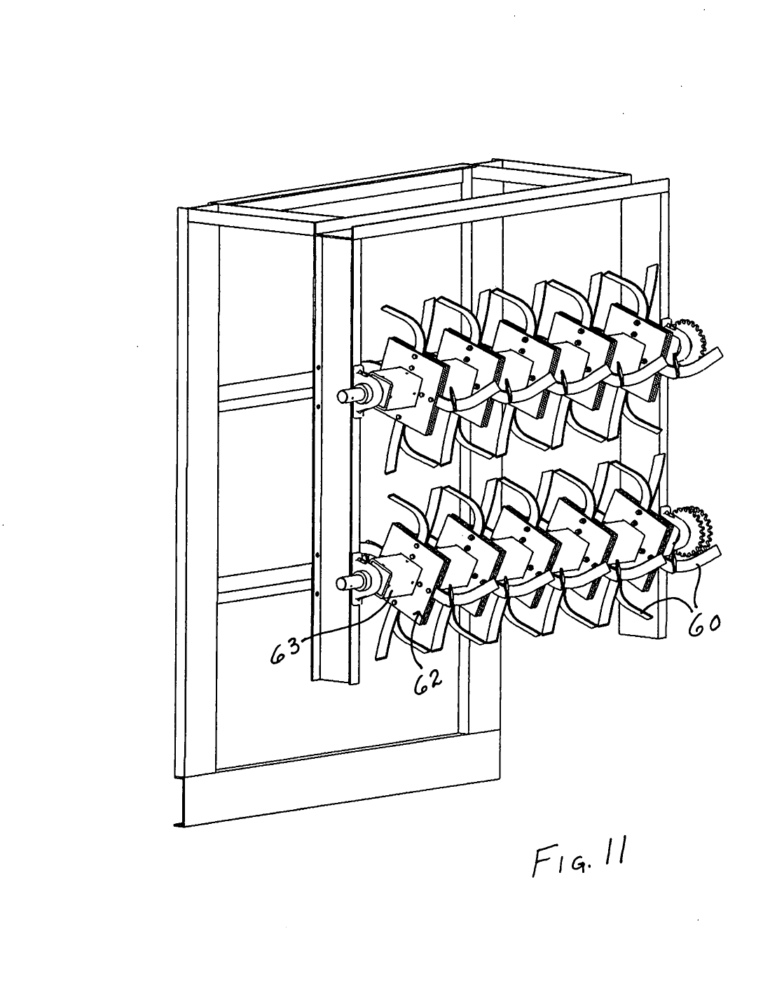

The elongated bed 15 includes a conveyer chain or apron 17 for moving a bale longitudinally along the bed toward the cutting knives in the mill 18. As illustrated in FIG. 10, the conveyer may comprise a continuous rubber belt instead of a chain. One advantage associated with using a belt is that it will not become frozen to the bed in very cold temperatures. Also, a continuous belt prevents leaves and other small particles of forage from being lost prior to processing of the material.

The conveyer and the mill are powered by means of a power take-off shaft 16 which may be connected to a tractor. It is also possible to power the conveyer with a hydraulic motor, if desired. The length of the bed 15 may vary, although a length of about 18 feet is preferred. The width of the bed may also vary, but it preferably is at least about 6.5 feet wide to accommodate large square and round bales. When the apparatus utilizes a chain conveyer for the forage material, the bed floor may be slatted to enable rocks, dirt, and other debris to fall through to the ground.

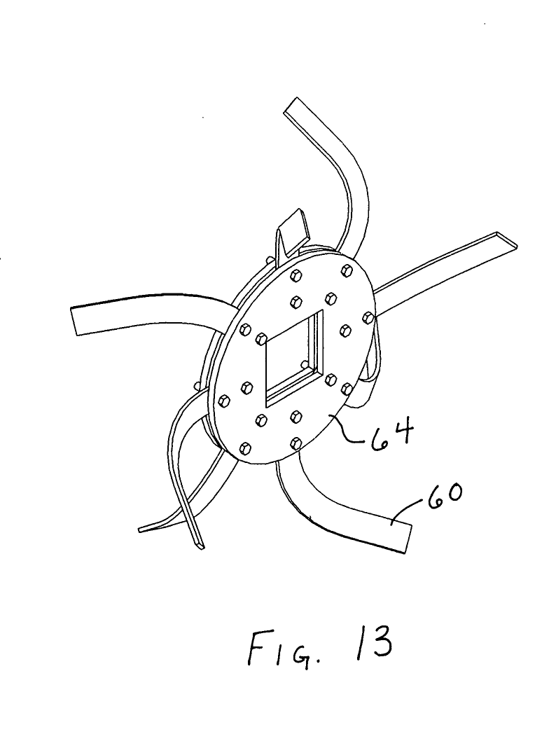

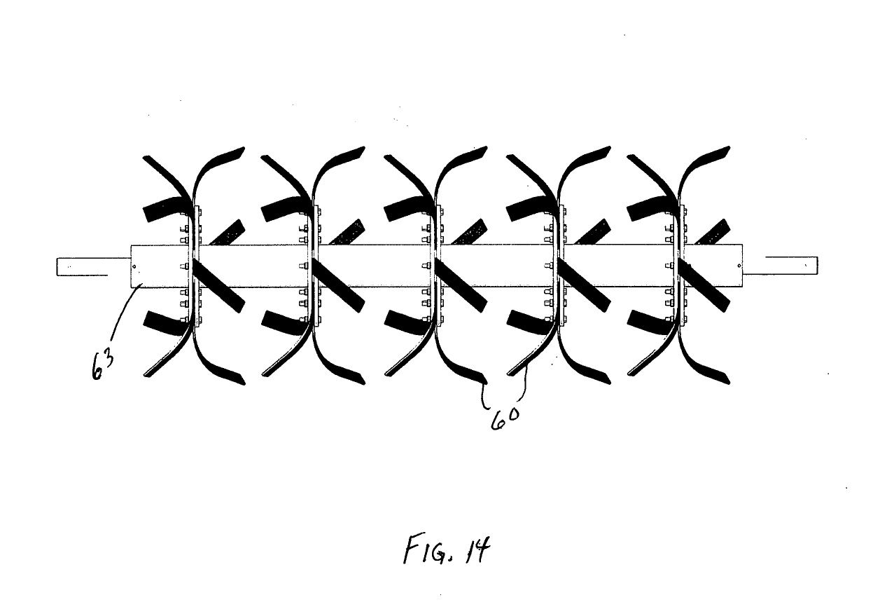

At the rearward end of the bed there may also be included (as an option) a pivotable bed extension 44 for carrying one or more additional bales to be processed. This is shown in FIG. 13. When the bale(s) are carried on the extension, the extension may be in a nearly horizontal plane. Then when it is desired to move the bale(s) forward onto the apron 17 on the main part of the bed, the rear end of the extension may be simply raised by means of a hydraulic cylinder 46. Because the front edge of extension 44 is pivoted on pins 45, lifting of the extension 44 will cause the bale(s) to slide forward and be engaged by the apron on the bed. Preferably the extension bed has a slatted floor so that dirt and debris sticking to the bale(s) can fall through the extension to the ground. Also the bed extension, when raised to an upright position, shortens the turning radius and improves operator visibility toward the rear of the apparatus.

Also included in the bale processor is a transverse conveyer or dispensing means 20. The transverse conveyer extends beneath the processing mill 18 at the forward end of the bed. Forage material which is cut loose from a bale falls downward onto the transverse conveyer where it is transported or conveyed laterally away from the bed (for example, it may be conveyed to a feedbunk alongside the processor). The width of the conveyer may vary, e.g. from about 18 to 30 inches. Preferably, the transverse conveyer has a length greater than the width of the bed so that the conveyer extends laterally outward from each side of the bed (e.g. about 18 inches or so). It is also preferable for the transverse conveyer to be able to be driven in two directions (i.e. either to the left or to the right side of the bed 15) so that the conveyer can be used to fill a feedbunk on either side of the bed. Preferably, conveyer 20 is powered by a hydraulic motor 21.

It is also possible for the bale processor to include a powered fan for blowing the processed forage material outwardly from the end of the transverse conveyer. This is illustrated in FIG. 16. The fan or blower may comprise a housing 50 with an elongated directional spout 51. The housing may also include appropriate hooks or fingers 52 to enable one end of the housing to be removably attached to the shroud 19 at the forward end of the apparatus (e.g. by engaging the tabs 19A). The housing is sufficiently large that it will fit over the end of the transverse conveyer to be able to receive forage material from that conveyer. The blower or fan (which may be a turbine-type fan) is preferably powered by a hydraulic motor 53 appropriately connected to the hydraulic system of the tractor. Preferably the blower or fan can be attached to either end of the transverse conveyer so that the forage material may be blown outwardly from either side of the apparatus, as desired.

The bale processor can be easily and efficiently powered by means of a power take-off shaft from a tractor, for example, to power a gear box 40 with associated gear 42. The other shafts 18A and associated knives can be driven off gear 42 using chains 22 and gears 18B.

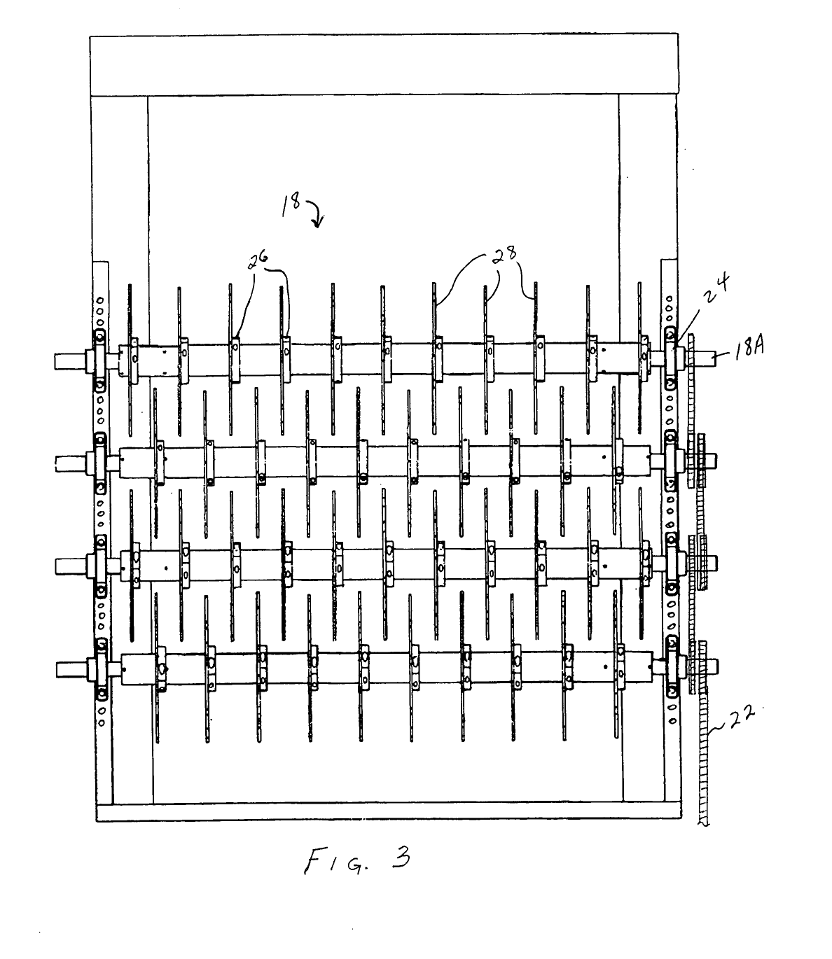

FIG. 3 is an elevational view looking into the cutting mill from the bed 15. In the embodiment shown there are four transverse shafts 18A. Each end of each shaft is supported by a pillow block 24 on vertical frame member 25. The vertical spacing between shafts 18A may be easily changed by removing the bolts fastening blocks 24 to frame section 25 and then moving the blocks 24 upwardly or downwardly as desired and re-inserting the bolts. By moving the shafts 18A closer together, the forage material being processed would be subject to more vigorous cutting action than if the shafts were moved further apart. Preferably all the shafts 18A are rotated in the same direction for processing baled forage material. The direction of rotation of the shafts can be changed, if desired. The number of shafts 18A may vary, depending upon the size of the bales being processed and the diameter of the cutting blades. For example, if the bales are of smaller diameter, it may only be necessary to have two or three rows of cutting knives. In any event, with the design of the present invention, it is possible to easily add or remove shafts 18A as needed.

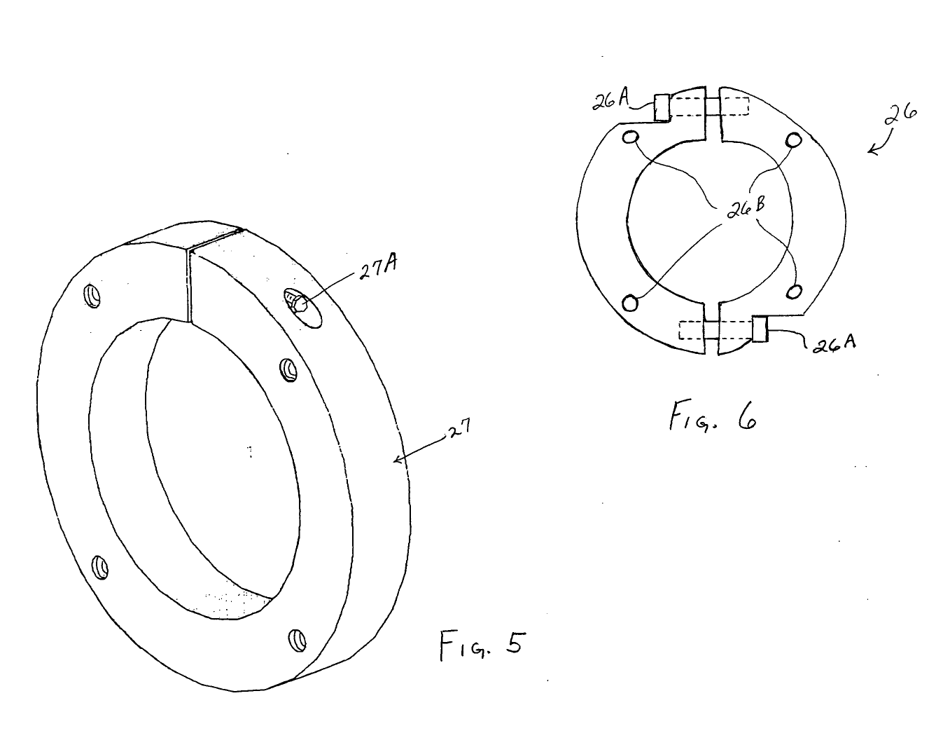

Preferably the shafts 18A are cylindrical. The portion of the shaft which carries the cutting knives is tubular and preferably is about 4 inches in diameter. The cutting blade sections are preferably bolted to hubs or collars which are in turn fastened to the shafts 18A. In FIG. 6 there is shown a two-piece hub 26. Bolts 26A extend from one section to the other and when tightened will secure the hub or collar to a cylindrical shaft. The hub includes a plurality of threaded openings 26B for enabling a cutting blade section to be bolted thereto. Another type of hub 27 is shown in FIG. 5. This hub is unitary but is split on one side to enable it to fit over a shaft 18A. Then bolt 27A is used to tighten the hub or collar onto the shaft. This hub also includes a plurality of threaded openings for enabling cutting blade sections to be secured thereto.

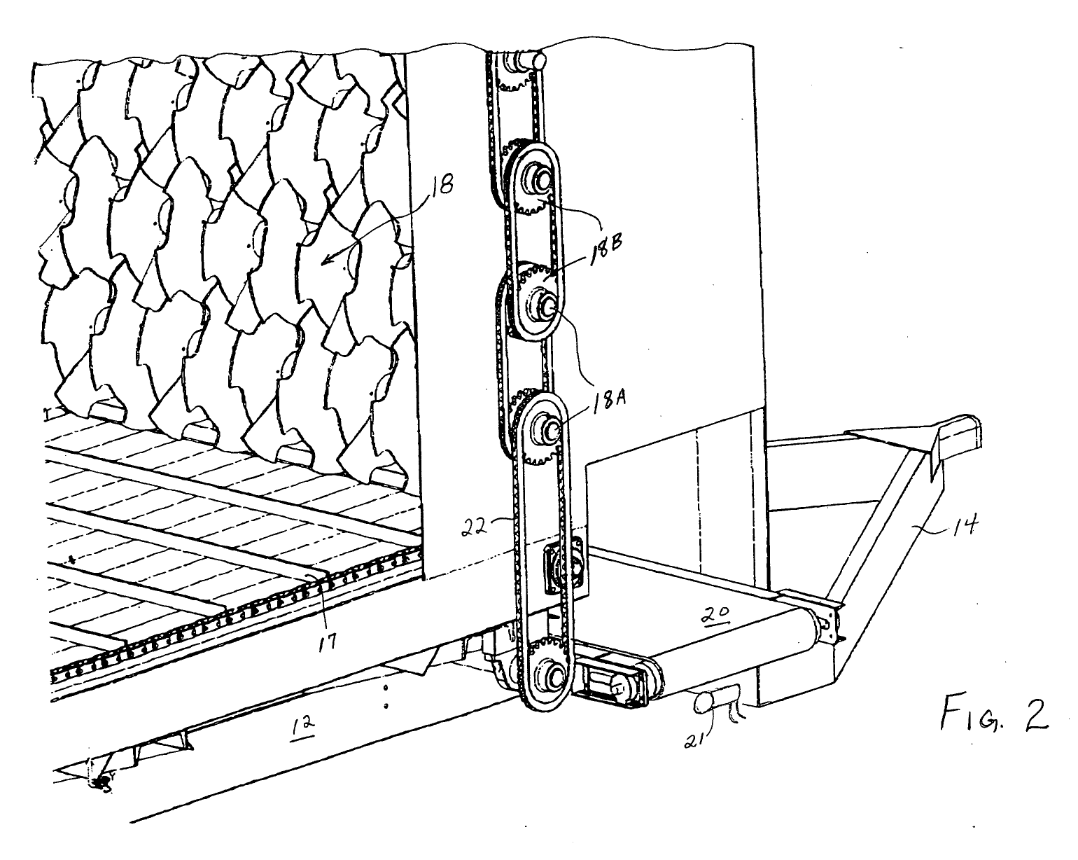

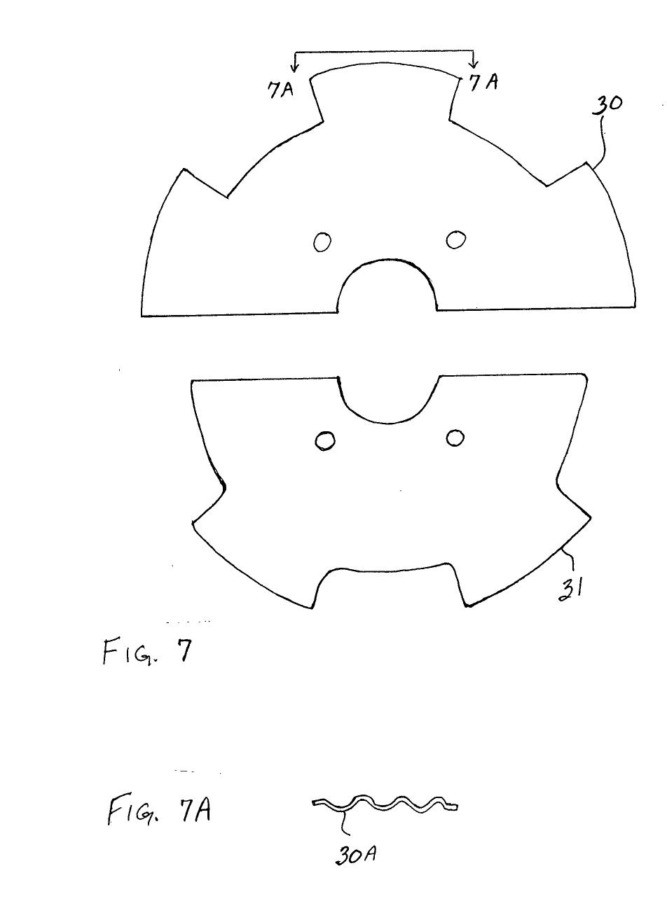

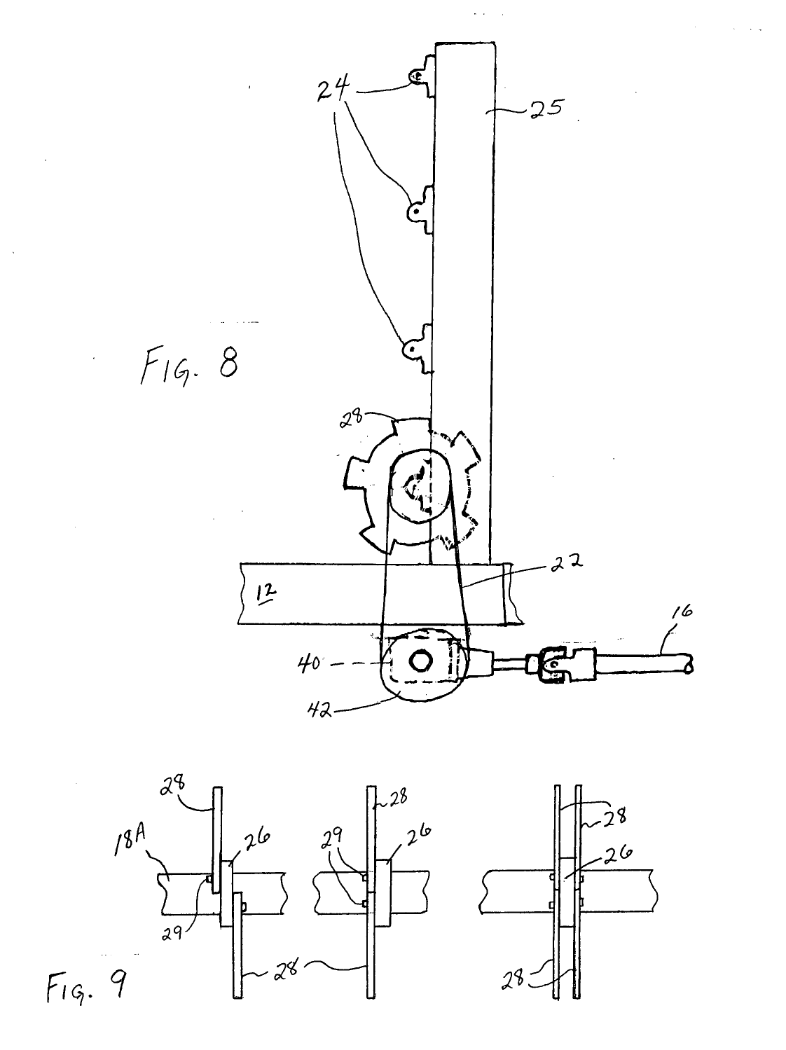

One type of cutting blade for use in the apparatus of this invention is illustrated in FIGS. 2, 3, 4, 7 and 7A. This type of cutting blade comprises two separate sections which may be individually secured to a hub or collar by means of bolts extending through the cutting sections. The cutting blade preferably is serrated or scalloped on its periphery so as to be more aggressive in its ability to cut baled forage material. The size and shape of the cutting blades may vary, as desired. For example, the blade diameter may vary from about 12 inches up to about 24 inches or even larger. In FIGS. 7 and 7A there is shown one embodiment of a notched cutting blade which is useful in this invention. The blade comprises sections 30 and 31. As shown in FIG. 7A, the teeth on the blade may be rippled in cross-section.

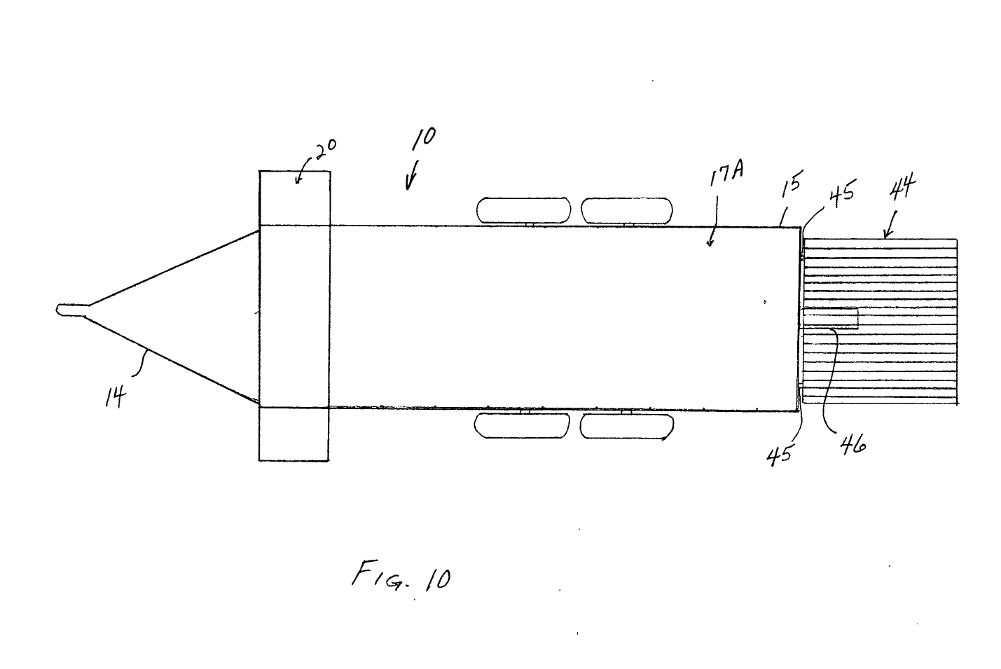

As illustrated in FIG. 9, the cutting blades may be secured to the shaft 18A in a number of different ways. For example, cutting blade sections 28 may be secured to opposite sides of the same hub 26 by means of bolts 29, or they may be secured to the same side of the hub. As another alternative, there may be four different cutting blade sections 28 secured to the same hub. This type of mounting flexibility may be very important in certain situations. For example, it is easy to add or remove cutting blades from any of the shafts at any time without disassembly of the entire processing mill.

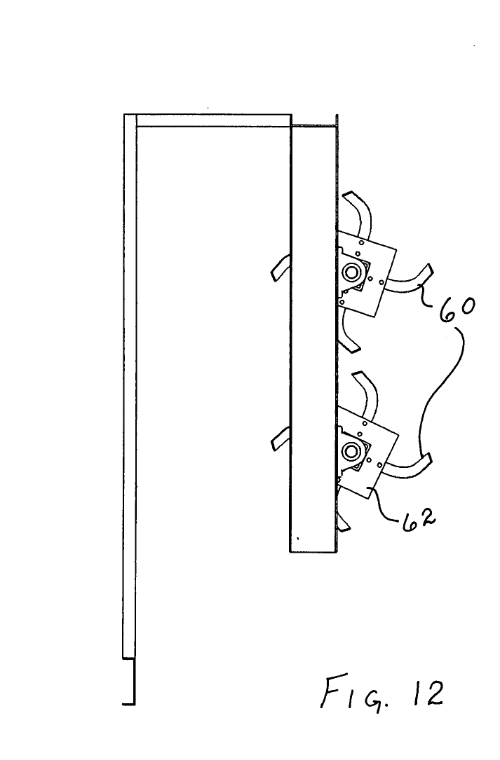

In FIGS. 11 and 12 there is illustrated another embodiment of a mill for use in this invention. In this embodiment, the cutting blades 60 are not planar. Rather, the blades extend outwardly from the shaft in a perpendicular manner and then curve laterally off to one side. Some of the blades curve off to the left while others curve off to the right. The length and width of these blades may vary, as desired. In the embodiment shown in FIGS. 11 and 12, the blades are secured to a square hub 62 on square shaft 63. Several blades may be secured to each hub.

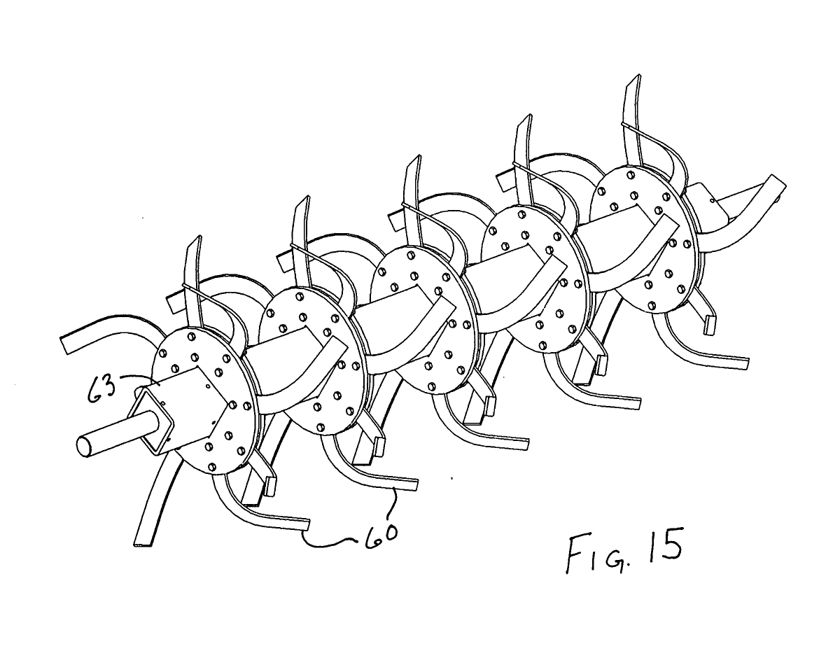

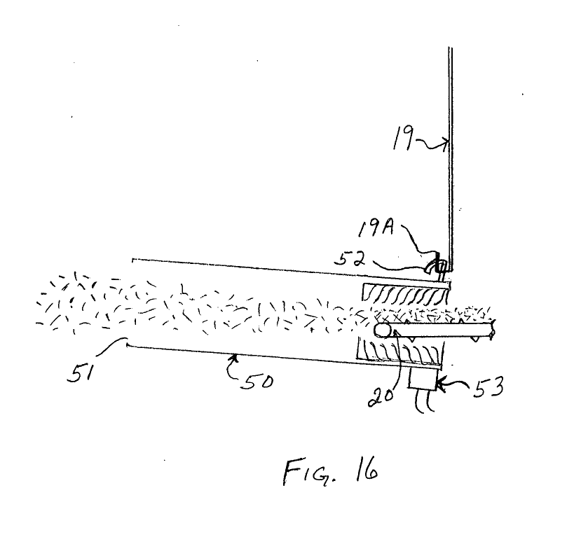

In FIGS. 13-15 there is illustrated the use of curved cutting blades 60 which are secured to a circular or disk-shaped hub 64. This type of hub enables many blades 60 to be secured thereto. Preferably the hub 64 fits onto a square shaft, as shown in FIGS. 14 and 15.

A significant advantage of the type of blade systems used in the present invention is that the number and type of cutting blades used may be varied as needed or desired for any particular type of material being processed. Another significant advantage is that the spacing between adjacent blades may also be changed, as desired or needed. The size of the cutting blades can also be changed. Because it is possible to adjust or change the spacing between adjacent blades, or change the size of the blades, it is possible to adjust the length of cut of the forage material from less than about 2 inches in length to about 16 inches. Previous bale processors do not have this capability. By changing the PTO speed of the tractor, it is also possible to change the length of cut material.

The bale processor of this invention can be operated with a small tractor (e.g. about 25 horsepower). Other types of bale processors do not have this capability.

Other variants are possible. For example, the elongated bed 15 does not have to be mounted to a wheeled frame as shown. It is possible for the bed to be mounted on a truck frame, for example. It is also possible for the bed to be located in a fixed or stationary location (e.g. next to a barn or a stack of bales to be processed). It is also possible for the processor to be powered by an electric or gas motor instead of using a tractor for power. The number and size of the cutting blades may also vary. Because additional cutting blades can be added to the hubs, as desired, the speed with which forage material may be cut or processed can be increased, for example. Increasing the speed of rotation of the cutting blades can also increase the speed at which the forage material can be processed. The apparatus of this invention is very adaptable to changing types of forage material, e.g. by allowing the number and type of cutting blades to be easily changed to accommodate changing conditions.

What is claimed is:

1. Bale processing apparatus comprising:
(a) an elongated bed having first and second ends for supporting a bale of forage to be processed;
(b) mill means supported at said first end of said bed; wherein said mill means comprises at least one rotatably driven transverse shaft with a plurality of cutting means secured thereto;
(c) conveyer means on said bed for advancing said bale longitudinally along said bed toward said mill means;
(d) dispensing means adjacent said mill means for dispensing cut material from said bale laterally relative to said bed; wherein said dispensing means is adapted to dispense said cut material selectively to the left or to the right side of said bed.

2. Apparatus in accordance with claim 1, wherein said dispensing means comprises a conveyer mounted below said mill means.

3. Apparatus in accordance with claim 1, wherein said cutting means comprises a plurality of disks each having a serrated edge.

4. Apparatus in accordance with claim 1, wherein said mill means comprises a plurality of rotatably driven transverse shafts each having a plurality of cutting means secured thereto.

5. Apparatus in accordance with claim 1, wherein said transverse shaft is gear-driven.

6. Apparatus in accordance with claim 1, wherein said conveyer means is driven by a hydraulic motor.

7. Apparatus in accordance with claim 1, further comprising a bed extension pivotably attached to said second end of said bed for carrying a supplemental bale to be processed.

8. Apparatus in accordance with claim 7, wherein said bed extension is pivotable between lowered and raised positions to enable a bale on said extension to slide onto said conveyer means on said bed.

9. Apparatus in accordance with claim 4, wherein each said shaft has a gear secured thereto, and wherein drive chains are attached between adjacent shafts.

10. Apparatus in accordance with claim 4, wherein said transverse shafts are carried by a vertical frame member.

11. Apparatus in accordance with claim 10, wherein each Said transverse shaft is attached to said vertical frame member by means of pillow blocks.

12. Apparatus in accordance with claim 1, wherein there are a plurality of cutting blades secured to each said transverse shaft by means of split hubs.

13. Apparatus in accordance with claim 12, wherein each said cutting blade comprises a partial disk.

14. Apparatus in accordance with claim 1, wherein the axial spacing of said cutting blades on said shaft is adjustable.

15. Apparatus in accordance with claim 1, wherein each said cutting blade extends radially outward from said shaft and then curves laterally.

16. Bale processing apparatus comprising:
(a) an elongated bed having first and second ends for supporting a bale of forage to be processed;
(b) mill means supported at said first end of said bed; wherein said mill means comprises at least one rotatably driven transverse shaft supporting a plurality of elongated cutting blades each having inner and outer ends; wherein said inner end is generally perpendicular to said horizontal shaft and wherein said outer end curves laterally away from a line which is perpendicular to said shaft;
(c) conveyer means on said bed for advancing said bale longitudinally along said bed toward said mill means;
(d) dispensing means adjacent said mill means for dispensing cut material from said bale laterally relative to said bed.

17. Apparatus in accordance with claim 16, wherein said inner ends of said cutting blades are secured to said horizontal shaft by means of a flange surrounding said shaft.

18. Apparatus in accordance with claim 17, wherein each said flange has four sides, and wherein two of said cutting blades are secured to each said side.

19. Apparatus in accordance with claim 16, wherein said conveyer means comprises a continuous belt.

20. Apparatus in accordance with claim 16, further comprising blower means for receiving cut forage material from said conveyer means and blowing said material outwardly away from said apparatus.
